(19) United States
(12) Patent Application Publication
(10) Pub. No.: US 2005/0110675 A1
(43) Pub. Date: May 26, 2005

(54) Method and apparatus for the FMCW principle

(75) Inventors: Wilhelm Gruener, Ulm (DE); Josef Burger, Holzheim (DE); Manfred Patzwahl, Lehr (DE)

Correspondence Address: CROWELL & MORING LLP;INTELLECTUAL PROPERTY GROUP, P.O. BOX 14300, WASHINGTON, DC, 20044-4300, US

(73) Assignee: EADS DEUTSCHLAND GmbH, Ottobrunn (DE)

(21) Appl. No.: 10/954,364

(22) Filed: Oct. 1, 2004

(30) Foreign Application Priority Data
Oct. 2, 2003 (DE) 103 46 047.0

(51) Int. Cl. G01S 13/42

(52) U.S. Cl. 342/128; 342/196; 342/133; 342/146

(57) ABSTRACT

A method and a system for scanning a definable field with respect to the azimuth and range direction according to the FMCW radar principle. A first Fourier transform of the receive signal is carried for the resolution of a receive signal in the azimuth direction, and another Fourier transform is carried out for each azimuth direction for the resolution in the range direction.

This application claims the priority of German Application No. 103 46 047.0, filed Oct. 2, 2003, the disclosure of which is expressly incorporated by reference herein.

### BACKGROUND AND SUMMARY OF THE INVENTION

The invention relates to a method and a system according to the FMCW radar principle for scanning a definable field for azimuth and range direction.

From the state of the art, FMCW (Frequency Modulated Continuous Wave) radar methods are known by which the antenna lobe is swivelled over the azimuth region to be resolved. These methods are also called frequency scan methods. One disadvantage of these methods is the high scanning rate of the analog/digital converters used in the FMCW radar units. Additional disadvantages are the coupling of the range resolution with the azimuth resolution, the high required bandwidth and the high losses of the frequency scan antenna.

It is an object of the invention to provide a method according to the FMCW radar principle by which the scanning of a definable field can take place at a high image regeneration rate. Another object consists of providing a radar system by which this method can be implemented.

According to the invention, in order to resolve a receive signal in the azimuth direction, a first Fourier transform of the receiving signal is carried out, and, in order to provide resolution in the range direction, another Fourier transform is carried out for each azimuth direction.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic frequency response curve for the FMCW radar method;

FIG. 2 is a basic diagram of the FMCW radar method according to the invention;

FIG. 3 shows an example of a block diagram of an FMCW radar system according to the invention;

FIG. 4 is a view of an example of a block diagram of the signal processing unit.

### DETAILED DESCRIPTION OF THE PREFERRED EMBODIMENT

The following is a description of the basic concepts of the range determination and of the azimuth determination according to the FMCW radar principle.

In the case of an FMCW radar, a linearly frequency-modulated transmit signal is normally used. FIG. 1 illustrates an example of a representation of the form of a frequency-modulated send and receive signal. The frequency response curve of the send signal has the reference symbol F_Tx, and the frequency response curve of the receive signal has the reference symbols F_Rx_1 and F_Rx_max.

The range determination in the case of an FMCW radar takes place by way of a frequency analysis of the frequency difference Δf between the transmit signal and the receive signal. The slope of the ramp is essentially determined by the following application parameters:
by the range resolution or by the bandwidth RF_BW,
by the image regeneration rate or by the rise time T_ramp of the frequency modulation.

Thus, a slope of the ramp is obtained according to:

$$SLOPE = \frac{RF\_BW}{T\_RAMP}$$

The required bandwidth RF_BW for a desired range resolution is obtained as follows:

$$RF\_BW = \frac{c}{2 Δ R}$$

Accordingly, for a range resolution of, for example, ΔR=1 m, the bandwidth is RF BW=150 MHz.

The rise time T_ramp is to be equated with the dwell time of the transmit beam on the target. For a dwell time of, for example, T_ramp=1 ms, the following is obtained for the slope of the ramp: SLOPE=150 kHz/μs.

In the case of the FMCW radar method, in contrast to the pulse radar method, the maximal frequency fed to the analog/digital converter is not the bandwidth but the maximal frequency difference Δf_max between the transmit and receive signal (FIG. 1).

The maximal frequency difference Δf_max is determined as follows from the range to be maximally resolved and the slope of the ramp:

$$SLOPE = \frac{RF\_BW}{T\_RAMP} = \frac{Δ f}{Δ t} = \frac{Δ f\_max}{Δ t\_max}$$

$$c = \frac{2 R\_max}{Δ t} ⇒ Δ t = \frac{2 R\_max}{c}$$

For a maximal range R max of, for example, 5 km, the following is therefore obtained for Δt_max=33.3 μs. The maximal frequency difference Δf_max is obtained according to Δf_max=Δf_max*SLOPE=33.3=33.3 μs*150 kHz/μs=MHz.

It thereby becomes possible to significantly reduce the sampling rates of the analog/digital converters by means of the FMCW radar method.

The field to be scanned is normally resolved with respect to the azimuth by means of a single send and receive beam which swings over a definable angular range. The scanning time required for scanning the defined angular range is obtained as follows:

$$t\_s = \frac{α}{φ} * t\_dwell$$

wherein t_s: scanning time
α: angular range
φ: beam width
t_dwell: dwell time of the beam in an angular segment

According to the invention, a fan-shaped radiation diagram is generated by means of a first Fourier transform, which diagram includes a plurality of individual beams. In this case, the directions of the beams correspond to the individual azimuth directions. In particular, each receive module of the antenna array of the receive antenna is the starting point for all azimuth directions.

In particular, the Fourier transform is an N-point Fourier transform, N being the number of the receive modules.

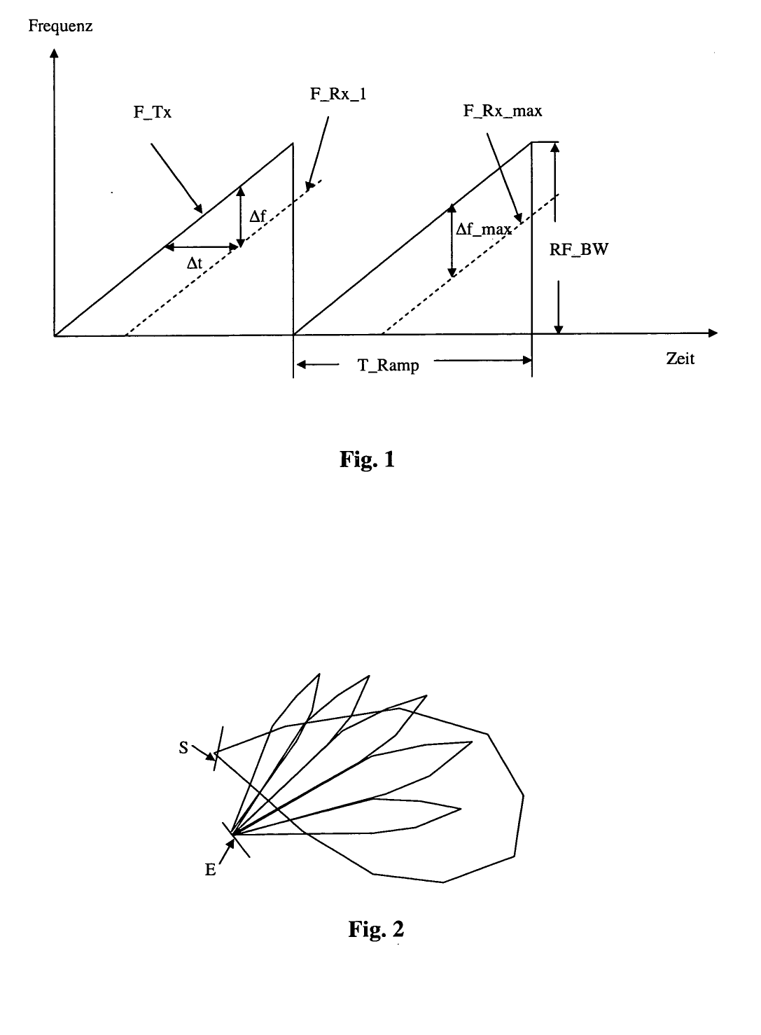

As an example, FIG. 2 shows a basic diagram of the FMCW radar method according to the invention. The transmit antenna and the receive antenna are spatially separate from one another. The transmit antenna S emits a transmit signal with a broad radiation pattern. The receive antenna E has a fan-shaped radiation pattern over a defined angular range α, individual narrow beams of this pattern being oriented along definable azimuth directions.

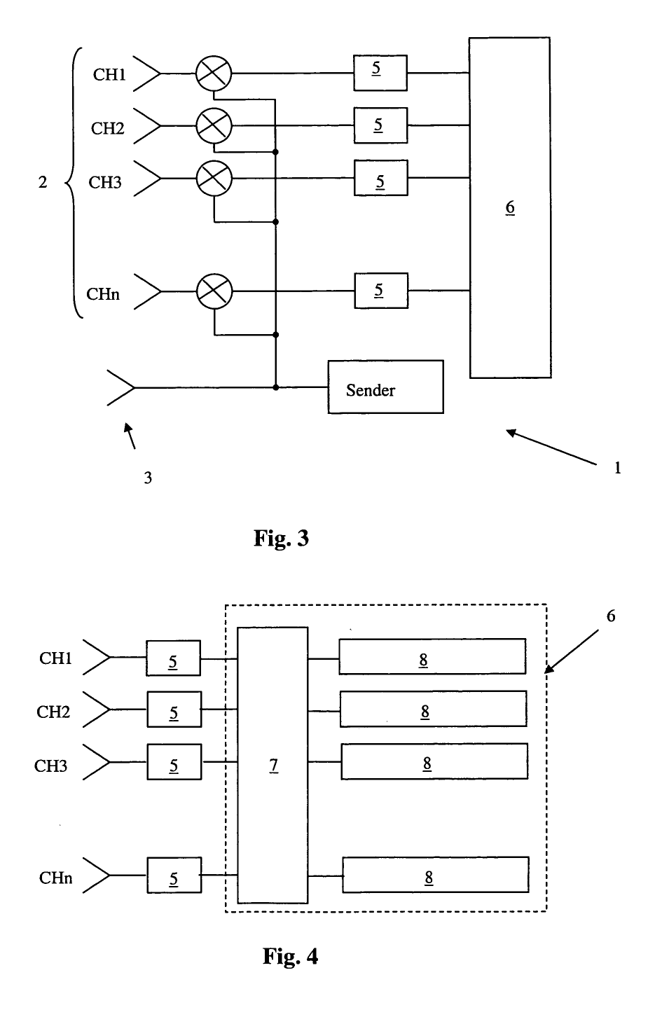

As an example, FIG. 3 shows a block diagram of an FMCW radar system according to the invention. The radar system 1 includes a transmit antenna 3 and a receive antenna 2 with a plurality of receive modules CH1 . . . CHn. The receive modules CH1 . . . CHn are connected with the inputs of mixers 4 for comparing the receive signal with the transmit signal. The outputs of the mixers 4 are each connected with analog/digital converters 5. The analog/digital converters 5 are connected to a multi-channel signal processing unit 6.

As an example, FIG. 4 illustrates a block diagram of the signal processing unit 6. In the signal processing unit 6, the digital signal supplied by the analog/digital converters is first processed in a first Fourier transform 7. As a result, a beam shaping is achieved whereby the above-described finger-shaped radiation pattern of the antenna array is generated. Subsequently, another Fourier transform 8 is carried out for each channel CH1 . . . CHn, with the range being resolved for each channel.

The FMCW radar method according to the invention and the FMCW radar system according to the invention can be utilized, for example, as an all-weather approach aid, as a vehicle radar or as a monitoring radar for smaller fields, for example, airports. In the following, the technical details of an FMCW radar system according to the invention for an all-weather approach aid will be discussed, as an example. The system operates by means of millimeter waves at 35 GHz. The range to be scanned amounts to approximately 4 km with a range resolution of 2.0 m. The receive antenna with an aperture of 600 mm on 100 mm includes 128 receive modules with a spacing of 0.6 λ. Thus, it becomes possible to scan a field (field of view=FOV) of +/−30°. By means of this arrangement, a beam width in the azimuth of 10 and a theoretical antenna amplification of 36 dB can be achieved.

The transmit aperture illuminates to an entire field FOV of +/−300. This requires a transmit antenna with a transmit aperture of 35 mm on 100 with an antenna gain of 18 dB.

After the digital beam shaping, corresponding to the 128 receive modules, 128 receive beams are generated at an angular spacing of 0.7° in the antenna viewing direction, of which approximately 80 antenna viewing directions are processed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method of scanning a definable field with respect to the azimuth and range direction using FMCW radar; comprising the steps of:
carrying out a first Fourier transform of the receive signal for resolving a receive signal in the azimuth direction; and
carrying out another Fourier transform for each azimuth direction in order to provide resolution in the range direction.

2. A method according to claim 1, further comprising the step of conducting the receive signal from an antenna array having a plurality of receive modules (CH1, . . . ,CHn) to a multi-channel signal processing unit.

3. The method according to claim 2, wherein analog/digital converters are respectively connected between each of the receive modules (CH1, . . . ,CHn) and the signal processing unit.

4. The method according to claim 3, wherein a number of channels of the signal processing unit corresponds to a number of receive modules (CH1 . . . CHn).

5. The method according to one of claim 2, wherein computations of the first and second Fourier transforms are carried out in the signal processing unit.

6. The method according to claim 1, comprising the further step of generating a multi-beam radiation diagram during the computation of the first Fourier transform, each receive module (CH1, . . . ,CHn) being the starting point of all azimuth directions.

7. The method according to claim 6, wherein a definable number of receive modules (CH1, . . . ,CHn) are used for computing the radiation diagram.

8. The method according to claim 1, wherein a maximal frequency difference Δf between the transmit and the receive signal is determined when computing the second Fourier transform.

9. A FMCW radar system for implementing the method according to claim 1, wherein the radar system comprises a transmit antenna and an antenna array with a plurality of receive modules (CH1, . . . ,CHn).

10. The radar system according to claim 9, wherein each receive module (CH1, . . . ,CHn) is connected with an input of a analog/digital converter.

11. The radar system according to claim 10, wherein an output of each analog/digital converter is connected with the signal processing unit.

12. The radar system according to claim 9, wherein spacing of the receive modules (CH1, . . . ,CHn) corresponds to at least half of an operating wavelength of the system.

13. The method according to one of claim 3, wherein computations of the first and second Fourier transforms are carried out in the signal processing unit.

14. The method according to one of claim 4, wherein computations of the first and second Fourier transforms are carried out in the signal processing unit.

15. The method according to claim 2, comprising the further step of generating a multi-beam radiation diagram during the computation of the first Fourier transform, each receive module (CH1, . . . ,CHn) being the starting point of all azimuth directions.

16. The method according to claim 3, comprising the further step of generating a multi-beam radiation diagram during the computation of the first Fourier transform, each receive module (CH1, . . . ,CHn) being the starting point of all azimuth directions.

17. The method according to claim 4, comprising the further step of generating a multi-beam radiation diagram during the computation of the first Fourier transform, each receive module (CH1, . . . ,CHn) being the starting point of all azimuth directions.

18. The method according to claim 2, wherein a maximal frequency difference Δf between the transmit and the receive signal is determined when computing the second Fourier transform.

19. The method according to claim 3, wherein a maximal frequency difference of between the transmit and the receive signal is determined when computing the second Fourier transform.

20. A method of scanning a field, comprising the steps of:
providing a frequency modulated transmit signal;
providing a plurality of reception modules for obtaining a plurality of received signals from said field in response to said transmit signal;
comparing said transmit signal to each of said plurality of receive signals and outputting a plurality of mixed signals;
performing a first Fourier transform on said plurality of mixed signals to provide a beam shaping diagram having a plurality of individual beam each corresponding to individual azimuth directions, and
performing a second Fourier transfer for each of said plurality of mixed signals in order to resolve the range direction.
